(19) United States
(12) Patent Application Publication
(10) Pub. No.: US 2004/0115984 A1
(43) Pub. Date: Jun. 17, 2004

(54) Light socket assembly for use with conductors arranged in a ribbon cable

(76) Inventors: William J. Rudy, Annville, PA (US); David Fleming, Palmyra, PA (US)

Correspondence Address: Tyco Electronics Corporation, MS R20/2B, 307 Constitution Drive, Menlo Park, CA, 94025-1164, US

(21) Appl. No.: 10/317,722

(22) Filed: Dec. 12, 2002

(51) Int. Cl. H01R 4/24

(52) U.S. Cl. 439/405

(57) ABSTRACT

An electrical socket assembly including a contact organizer having a passage therethrough configured to receive a group of insulated conductive wires. The contact organizer includes notches that extend from a surface of the contact organizer to the passage. The electrical socket assembly also includes contacts securely held in the notches. The contacts have bottom portions configured to pierce insulation and engage the conductive wires. The contacts have upper portions extending beyond the notches. The upper portions are configured to engage conductive pads to convey at least one of power and data signals from the conductive wires.

### BACKGROUND OF THE INVENTION

The present invention relates to a light socket assembly for use with insulated conductors. More particularly, certain embodiments of the present invention relate to an overmolded organizer assembly for connecting a light source to conductors in an insulated ribbon cable.

In certain applications, for example holiday string lights, a series of light sockets are connected to one another through cable strips. The cable strips include insulated conductive wires that are twisted about each other. One type of light socket assembly includes a light source and metal contacts connected to opposite sides of the light source. Another type of light socket assembly includes contacts connected to a circuit board upon which the light source is mounted. The light sockets are joined in series through sections of cable strips. The wires in a first cable strip are soldered to a pair of contacts on a first side of the light socket and the wires of a second cable strip are soldered to a pair of contacts on an opposite second side of the light socket. The light sockets serve as conductors between the cable strips. A series of individual sections of cable strips are interconnected by the light sockets.

Alternatively, another conventional light string may include a continuous cable strip carrying at least two insulated wires twisted about each other. At evenly spaced points along the cable strip, the light sockets are connected to the cable strip. Typically, the light socket has an upper portion and a lower portion that are connected at a hinge. Thus, the upper and lower portions can be rotated away from each other to open and rotated toward each other to close. The upper portion carries a light source and contacts, such as insulation displacement contacts (IDCs), that are connected to the light source. The light socket is opened to receive the cable strip. The light socket is then closed about the cable strip such that the IDCs pierce the insulated wires and electrically connect the light socket to the cable strip.

However, conventional light socket assemblies for use with cable strips suffer from several drawbacks. First, the light socket assemblies are difficult and expensive to assemble. Soldering a series of cable strip sections to a series of light sockets is a time consuming process. Additionally, when using a continuous cable strip and a hinged light socket, it is difficult to accurately align the IDCs of the light socket with the entwined individual insulated wires when closing the light socket about the cable strip. The conventional light socket assemblies are also difficult to repair. The soldered wires cannot easily be removed from the contacts and thus replacing a defective contact within a light socket requires the removal of an entire cable strip or the re-soldering of the cable strip to the new contact. Also, a contact in the hinged light socket cannot be replaced without prying open the upper and lower portions of the light socket, replacing the contact, and then realigning the IDCs with the insulated wires. Furthermore, neither the soldered light sockets, nor the hinged light sockets, are tightly sealed about the cable strips at termination points (where the contacts engage the conductive wires) and thus permit contaminants to contact the wires at the termination points.

A need exists for an improved light socket assembly for use with conductive cable strips.

### BRIEF SUMMARY OF THE INVENTION

Certain embodiments of the present invention include an electrical socket assembly having a contact organizer with a passage therethrough configured to receive a group of insulated conductive wires. The contact organizer includes notches that extend from a surface of the contact organizer to the passage. The electrical socket assembly also includes contacts securely held in the notches. The contacts have bottom portions configured to pierce insulation and engage the conductive wires. The contacts have upper portions extending beyond the notches. The upper portions are configured to engage conductive pads to convey at least one of power and data signals from the conductive wires.

### BRIEF DESCRIPTION OF SEVERAL VIEWS OF THE DRAWINGS

FIG. 1 illustrates an isometric view of a light socket assembly formed according to an embodiment of the present invention.

FIG. 2 illustrates an isometric view of a ribbon cable formed according to an embodiment of the present invention.

FIG. 3 illustrates an isometric view of a ribbon cable and a contact organizer formed according to an embodiment of the present invention.

FIG. 4 illustrates an exploded isometric view of the light socket assembly of FIG. 1.

FIG. 5 illustrates a sectional side view taken along line 5-5 in FIG. 4 of a contact organizer and a ribbon cable formed according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentality shown in the attached drawings.

### DETAILED DESCRIPTION OF THE INVENTION

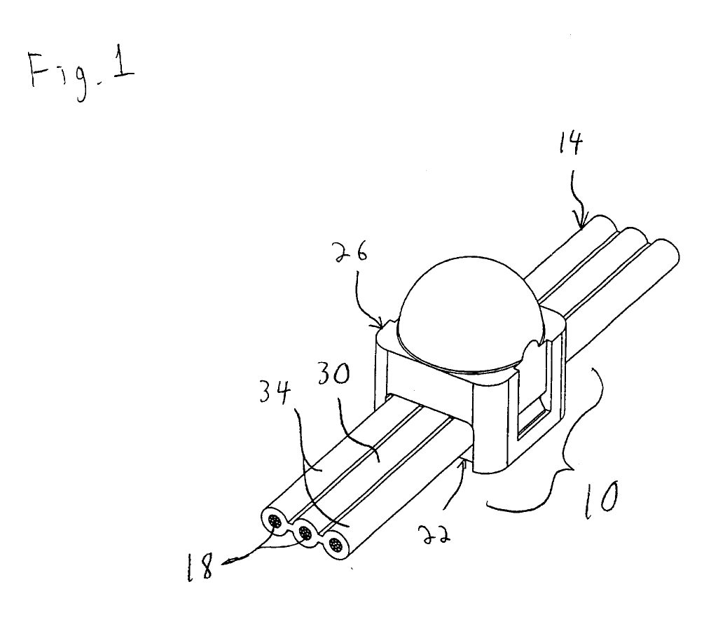

FIG. 1 illustrates an isometric view of a light socket assembly 10 formed according to an embodiment of the present invention. The socket assembly 10 includes an insulated contact organizer 22 and a light assembly 26 that are mounted to an insulated ribbon cable 14. The ribbon cable 14 includes an inner cable 30 positioned between outer cables 34. The inner and outer cables 30 and 34 are laminated to each other through PVC insulation in a planar arrangement. The inner and outer cables 30 and 34 each carry a conductive wire 18. The inner and outer cables 30 and 34 may be divided between one or more signal lines and one or more power lines. In the present example, the inner cable 30 is a power line, while the outer cables 34 are signal lines.

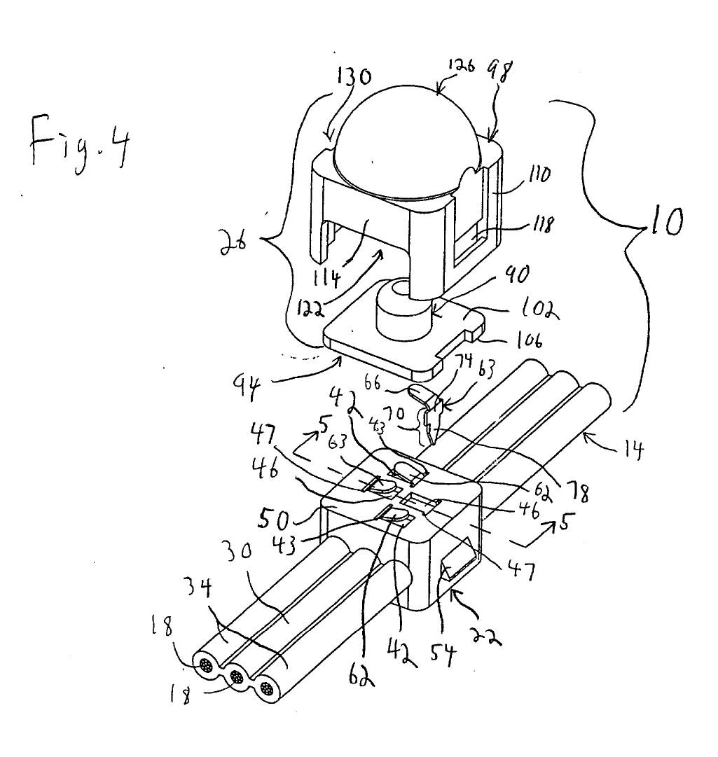

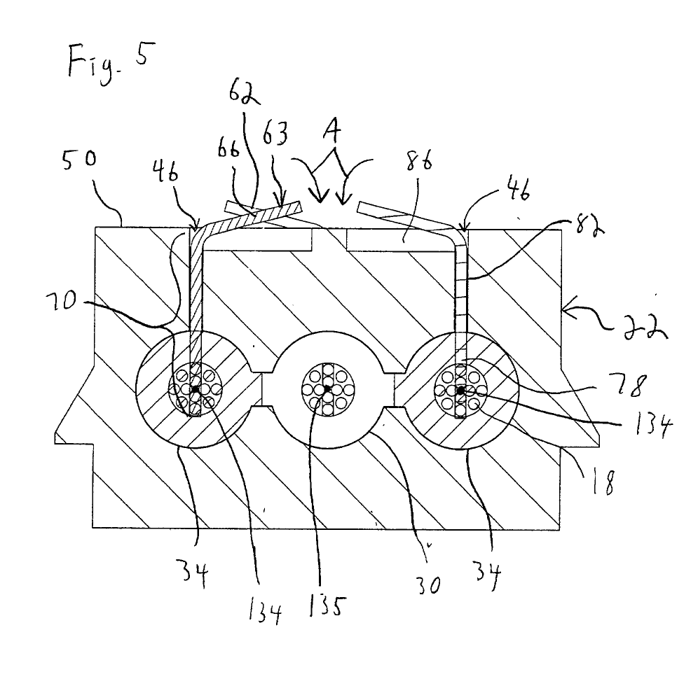

The contact organizer 22 is over molded about the ribbon cable 14 and electrically connected to the conductive wires 18 of the ribbon cable 14 as explained below in more detail in connection with FIGS. 4 and 5. The light assembly 26 is mounted to the contact organizer 22 and is configured to receive power from the inner cable 30 and data signals from the outer cables 34. The data signals activate and deactivate the light assembly 26.

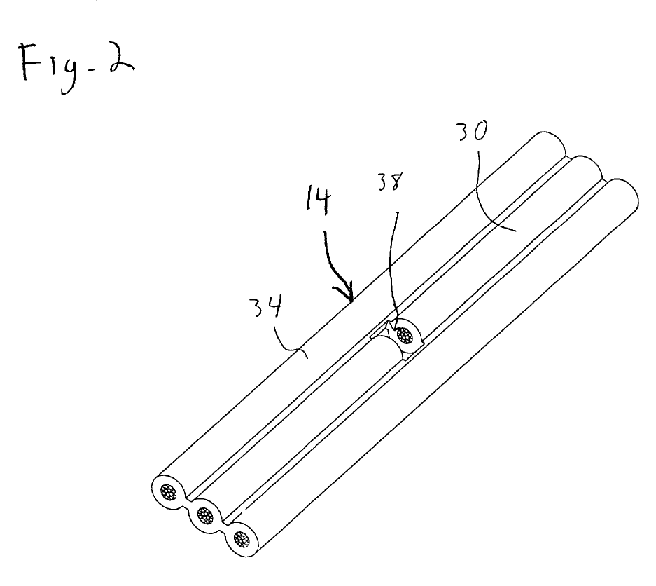

FIG. 2 illustrates an isometric view of the ribbon cable 14 with a section removed from the inner cable 30 to leave a gap 38 in the inner cable 30. The path of the electrical power through the inner cable 30 is interrupted by the gap 38, while the outer cables 34 remain in tact. During assembly, the gap 38 is formed in the inner cable 30 before the contact organizer 22 is overmolded onto the ribbon cable 14.

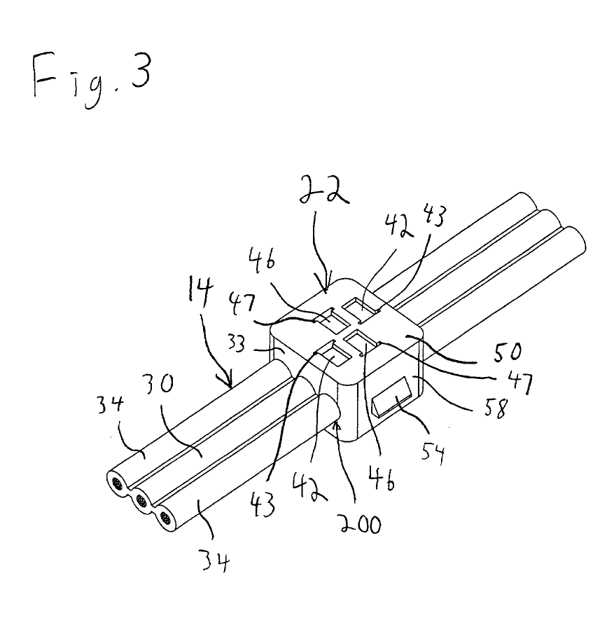

As shown in FIG. 3, once the gap 38 (FIG. 2) is formed, the contact organizer 22 is overmolded about the ribbon cable 14 at the point where the inner cable 30 contains the gap 38. The contact organizer 22 carries the inner and outer cables 30 and 34 in cylindrical passages 200 that extend between opposite end walls 33 of the contact organizer 22. The inner and outer cables 30 and 34 extend through the passages 200 and out of the end walls 33 of the contact organizer 22. The contact organizer 22 is generally cube shaped and has a top surface 50 and opposed side walls 58. The side walls 58 include triangular latches 54 projecting outward therefrom. The top surface 50 includes rectangular inner notches 42 and outer notches 46 formed therein. The inner and outer notches 42 and 46 are positioned generally above the inner and outer cables 30 and 34, respectively. The inner notches 42 include slots 43 located in line with one another above the inner cable 30. The outer notches 46 include slots 47 located remote from one another above corresponding outer cables 34.

FIG. 4 illustrates an exploded isometric view of the light socket assembly 10 of FIG. 1. The inner and outer notches 42 and 46 receive L-shaped power and data contacts 62 and 63, respectively. The power and data contacts 62 and 63 have planar top portions 66 formed at an obtuse angle with planar bottom portions 70. The bottom portions 70 have rectangular crossbeams 74 formed with pointed blades 78. The bottom portions 70 of the power and data contacts 62 and 63 are inserted into the slots 43 and 47 of the inner and outer notches 42 and 46, respectively. The top portions 66 of the power and data contacts 62 and 63 project at an acute angle from the top surface 50 of the contact organizer 22. The slots 43 and 47 securely hold the crossbeams 74 to direct the blades 78 of the bottom portions 70 into engagement with the conductive wires 18 of the inner and outer cables 30 and 34, respectively.

FIG. 5 illustrates a sectional side view of the contact organizer 22 and the inner and outer cables 30 and 34 of FIG. 4 taken along line 5-5. The outer notches 46 include horizontal channels 86 formed in the top surface 50. The outer notches 46 also include vertical channels 82 extending downward from the horizontal channels 86. The vertical channels 82 are aligned with centerlines 134 of the conductive wires 18. The bottom portions 70 of the data contacts 63 extend into the vertical channels 82 until the blades 78 pierce the insulated outer cables 34 and engage the conductive wires 18 along the centerlines 134. While not shown, the inner notches 42 also include horizontal channels 86 and vertical channels 82. Power contacts 62 are also inserted into the inner notches 42 until blades 78 pierce the insulated inner cable 30 and engage the conductive wire 18 along a centerline 135.

As shown in FIG. 5, the data contacts 63 in the outer notches 46 are bent such that top portions 66 extend at an acute angle from the horizontal channels 86. When the light assembly 26 (FIG. 1) is positioned on top of the contact organizer 22, the light assembly 26 pushes the top portions 66 downward along arrows A until the top portions 66 rest in the horizontal channels 86.

Returning to FIG. 4, the data contacts 63 received in the outer notches 46 engage the conductive wires 18 of the outer cables 34 and thus carry the data signals of the outer cables 34. Likewise, the power contacts 62 received in the inner notches 42 engage the conductive wire 18 of the inner cable 30 on opposite sides of the gap 38 (FIG. 2), and thus, one of the contacts 62 receives power from the inner cable 30.

The light assembly 26 includes a rectangular printed circuit board 94 and an insulated housing 98. The printed circuit board 94 has electrical pads or traces (not shown) located on a bottom surface 106 and a light source 90 connected to a top surface 102. The traces on the bottom surface 106 are positioned to engage the power and data contacts 62 and 63 when the printed circuit board 94 is mounted on the top surface 50 of the contact organizer 22. The traces convey data signals to logic gates on the printed circuit board 94 which, in turn, switch the light source 90 on and off. The traces also supply power to the light source 90. The housing 98 includes side walls 110 perpendicularly formed with end walls 114. The side walls 110 have rectangular latch catches 118 and the end walls 114 have rectangular cable gaps 122. A dome-shaped transparent or translucent lens 126 is connected to the housing 98 at a top end 130.

During assembly, the printed circuit board 94 is positioned on top of the power and data contacts 62 and 63 such that the electrical pads on the bottom surface 106 of the printed circuit board 94 engage the top portions 66 of the power and data contacts 62 and 63. The housing 98 of the light assembly 26 is then positioned on the contact organizer 22 and the printed circuit board 94 with the cable gaps 122 receiving the ribbon cable 14 and the latch catches 118 snapably receiving the latches 54. When the housing 98 is snapably secured about the contact organizer 22, the printed circuit board 94 is pressed firmly against the power and data contacts 62 and 63 such that the top portions 66 are biased at least partially into the horizontal channels 86 (FIG. 5).

In operation, the electrical pads on the printed circuit board 94 form a circuit with the power and data contacts 62 and 63. The data signals are carried from the outer cables 34 through the data contacts 63 and the printed circuit board 94 to the light source 90 and/or control logic gates. Likewise, the power signals are carried from the inner cable 30 on one side of the gap 38 (FIG. 2) through a corresponding power contact 62, the printed circuit board 94, the light source 90 and back down through the other corresponding power contact 62 on the opposite side of the gap 38. The power signals enable the light source 90 to give off light through the lens 126, while the data signals may control the color of the light emitted and the duration of time for which the light source 90 is activated. Additionally, the light socket assembly 10 conducts the power signals along the inner cable 30 from one side of the gap 38 to the other and thus serves as a power conductor. Therefore, several light socket assemblies 10 may be connected at different points along the length of the ribbon cable 14. For example, a twenty-foot long strip of ribbon cable 14 may have twenty light socket assemblies 10 terminated thereon.

In an alternative embodiment, the inner cable 30 may be continuous without a gap 38. Additionally, the ribbon cable 14 may include more or less than three conductive wires 18 and the conductive wires 18 may be laminated together side-by-side or entwined. The contact organizer 22 has a corresponding number of notches 42 for contacts 62 to engage the conductive wires 18. Also, the notches 42 may receive contacts 62 on the side walls 58 of the contact organizer 22 to engage the outer cables 34 with the top portions 66 extending up the side walls 58 to engage the printed circuit board 94.

Optionally, the contact organizer 22 need not be overmolded, but instead may be preformed in two pieces that sandwich the ribbon cable 14 therebetween. Alternatively, the contact organizer 22 may be formed as a single unitary structure with an opening formed in one side thereof to facilitate side loading of the contact organizer 22 onto the ribbon cable 14. As a further alternative, the contact organizer 22 may be formed with holes therethrough slightly larger than the inner and outer cables 30 and 34 to enable the contact organizer 22 to be slid over an end of the ribbon cable 14 to a desired point. The power and data contacts 62 and 63 may then be loaded to hold the contact organizer 22 in place. Optionally, if the contact organizer 22 is slid over an end of the ribbon cable 14, the contact organizer 22 may be crimped to be held in a desired place. Optionally, the contact organizer 22 may be used to connect cables to other electronic devices besides a light fixture.

Another alternative is to replace the power and data contacts 62 and 63 with insulation displacement contacts (IDCs) that are oriented transverse to the cables and that engage the conductive wires within the cables. Additionally, the outer cables 34 may have gaps 38 as well and the contact organizer 22 may have additional data contacts 63 to engage both sides of the outer cables 34. The printed circuit board 94 then can selectively pass data signals between the data contacts 63 and thus across the gaps 38.

The light socket assembly of the different embodiments confers several benefits. First, several light socket assemblies are all connected to a single strip of ribbon cable instead of being connected to several individual strips of ribbon cable. The light socket assembly is cheap and easy to mass produce because the organizer is simply overmolded about the ribbon cable at several intermittent points and then the contacts and light assembly are placed onto the organizer. The light socket does not require soldering or aligning the conductive wires with contacts. Additionally, the light socket is easy to repair. The light assembly is snapped off of the organizer and the contacts are pulled out of the notches to be replaced. Finally, the organizer forms a tight protective seal about the ribbon cable in order to prevent contaminants from engaging the conductive wires or the contacts.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An electrical socket assembly comprising:
a contact organizer having a passage therethrough configured to receive a group of insulated conductive wires, said contact organizer including notches that extend from a surface of said contact organizer to said passage; and
contacts securely held in said notches, said contacts having bottom portions configured to pierce insulation and engage the conductive wires, said contacts having upper portions extending beyond said notches, said upper portions being configured to engage conductive pads to convey at least one of power and data signals from the conductive wires.

2. The socket assembly of claim 1, wherein said bottom portions of said contacts have blades and said notches include channels aligned with centerlines of corresponding passages, said channels directing said blades to pierce insulation on conductive wires in said passages.

3. The socket assembly of claim 1, further comprising a circuit board having a lower side containing conductive pads that engage said upper portions of said contacts when said circuit board is abutted against said surface of said contact organizer.

4. The socket assembly of claim 1, wherein each of said notches in said contact organizer includes first and second channels that intersect one another, said first channels intersecting said passage, said second channels being aligned transverse to said passage proximate said surface of said contact organizer, said first channels in said notches receiving said bottom portions of said contacts and said upper portions of said contacts being deflectable into said second channels.

5. The socket assembly of claim 1, wherein said upper portions of said contacts extend at an acute angle to said surface of said contact organizer, said upper portions being deflectable down into said notches.

6. The socket assembly of claim 1, further comprising a light source connected to a circuit board, said circuit board having conductive pads that are electrically connected to said light source and that engage said upper portions of said contacts to electrically connect said light source to said contacts.

7. The socket assembly of claim 1, further comprising a light assembly including a housing that receives a light source, said housing having latch catches that snapably engage latches extending from said contact organizer in order to retain said light assembly and said light source to said contact organizer.

8. The socket assembly of claim 1, wherein said passage includes multiple parallel passages arranged adjacent one another and said contact organizer includes at least one notch proximate each of said passages.

9. The socket assembly of claim 1, wherein said passage includes multiple parallel passages arranged adjacent one another and said contact organizer includes at least two notches aligned with one of said passages.

10. The socket assembly of claim 1, further comprising a cable containing insulated inner and outer conductive wires laminated to one another, said inner conductive wire being configured to carry power, said outer conductive wires being configured to carry data signals.

11. The socket assembly of claim 1, wherein said contact organizer is overmolded onto the conductive wires.

12. An electrical socket assembly, comprising:
a cable carrying a conductive wire;
a contact organizer provided about said cable, said contact organizer including a notch extending from said cable to a surface of said contact organizer;
a contact removably inserted into said notch and engaging said conductive wire;
a circuit board mounted to said contact organizer, said circuit board having a trace that is electrically connected to said contact; and
a light assembly carrying a light source, said light assembly mounted about said contact organizer with said light source configured to engage said contact in order that said light source is electrically connected to said conductive wire.

13. The socket assembly of claim 12, wherein said contact includes a bottom portion having a blade and said notch includes a channel aligned with said conductive wire, said channel directing said blade to pierce insulation on said conductive wire.

14. The socket assembly of claim 12, wherein said contact has an upper portion and a bottom portion and said notch in said contact organizer includes a first channel and a second channel that intersect one another, said second channel being proximate said surface of said contact organizer, said first channel in said notch receiving said bottom portion of said contact and said upper portion of said contact being deflectable into said second channel.

15. The socket assembly of claim 12, wherein said contact has an upper portion extending at an acute angle to said surface of said contact organizer, said upper portion being deflectable down into said notch.

16. The socket assembly of claim 12, wherein said light source is connected to said circuit board, said trace on said circuit board being electrically connected to said light source to electrically connect said light source to said contact.

17. The socket assembly of claim 12, wherein said light assembly includes a housing having latch catches that snapably engage latches extending from said contact organizer in order to retain said light assembly and said light source to said contact organizer.

18. The socket assembly of claim 12, wherein said contact organizer includes multiple parallel passages arranged adjacent one another, said contact organizer including at least one notch proximate each of said passages.

19. The socket assembly of claim 12, wherein said contact organizer includes multiple parallel passages arranged adjacent one another and said contact organizer includes at least two notches aligned with one of said passages.

20. The socket assembly of claim 12, wherein said cable contains insulated inner and outer conductive wires laminated to one another, said inner conductive wire being configured to carry power, said outer conductive wires being configured to carry data signals.
